(19) United States
(12) Patent Application Publication
(10) Pub. No.: US 2025/0291569 A1
(43) Pub. Date: Sep. 18, 2025

(54) FIRMWARE PACKAGE CREATION APPARATUS, FIRMWARE PACKAGE CREATION PROGRAM, AND FIRMWARE UPDATE SYSTEM

(71) Applicant: TOSHIBA TEC KABUSHIKI KAISHA, Tokyo (JP)

(72) Inventor: Kai Arimitsu, Sunto Shizuoka (JP)

(21) Appl. No.: 19/053,447

(22) Filed: Feb. 14, 2025

(30) Foreign Application Priority Data
Mar. 14, 2024 (JP) 2024-040231

(51) Int. Cl. G06F 8/61; G06F 8/65

(52) U.S. Cl. CPC G06F 8/61; G06F 8/65

(57) ABSTRACT

According to one embodiment, a firmware package creation apparatus classifies a plurality of files contained in each of a plurality of pieces of firmware data by type as common files used in common in all types and files by device used only in a type as a target of each firmware data by type, creates a first compressed file by collectively compressing only the common files, creates a second compressed file by collectively compressing only the files by device with respect to each of the plurality of pieces of firmware data by type for all of the plurality of pieces of firmware data by type, and thereby, creates a plurality of the second compressed files based on the classification, and creates one firmware package by collectively compressing the first compressed file and the plurality of second compressed files.

### CROSS-REFERENCE TO RELATED APPLICATION

This application is based upon and claims the benefit of priority from Japanese Patent Application No. 2024-040231, filed on Mar. 14, 2024, the entire contents of which are incorporated herein by reference.

### FIELD

Embodiments described herein relate generally to a firmware package creation apparatus, a firmware package creation program, and a firmware update system.

### BACKGROUND

Devices including MFPs (multifunction peripherals), copy machines, and printers available in various types are widely used. The device stores firmware such as BIOS (Basic Input Output System) executed prior to an operating system at startup. Regarding the firmware, when upgrade of a function is necessary and when update is necessary due to a failure or the like, a repair person visits a customer's place and manually updates the firmware.

The firmware of the device is different for different types. Accordingly, firmware data by type created in a device manufacturer or the like is prepared in a management server of the manufacturer, and the repair person downloads the necessary firmware data by type from the management server or the like, stores the data in e.g., a portable storage medium such as a USB (Universal Serial Bus) memory, and visits the customer's place. One customer does not necessarily use only one type of device and the repair person may visit a plurality of customer's places in a fieldwork, it is necessary for the repair person to store firmware data by type for a plurality of types in a storage medium. Depending on the size of the firmware data by type, it may be impossible to store data for a plurality of types in one storage medium.

Accordingly, in related art, a technique of distributing a firmware package including common firmware used in common in a plurality of types of devices and specific firmware specific to each of the plurality of types is proposed.

However, in related art, any method of creating the firmware package is not mentioned. Accordingly, it is naturally assumed that a creator of firmware data distinctively creates the common firmware and the specific firmware.

On the other hand, the creator of the firmware may individually create firmware data with respect to each of the plurality of types of devices without distinction between the common firmware and the specific firmware. In this case, it may be impossible to use the technique proposed in related art.

### DESCRIPTION OF THE DRAWINGS

FIG. 1 is a diagram for explanation of an example of a configuration of a firmware update system according to an embodiment.

FIG. 2 is a diagram for explanation of an example of a configuration of a repair person terminal as a firmware package creation apparatus according to the embodiment included in the firmware update system.

FIG. 3 is a diagram for explanation of an example of a configuration of an MFP as a device included in the firmware update system.

FIG. 4 is a sequence chart for explanation of an operation of the firmware update system.

FIG. 5 is a diagram for explanation of a relationship between firmware data by type and a firmware package for all types.

FIG. 6 shows a first part of a flowchart showing an example of a main procedure of information processing executed by a processor of the repair person terminal.

FIG. 7 shows a second part of the flowchart.

FIG. 8 shows a third part of the flowchart.

FIG. 9 is a diagram for explanation of an example of a record structure of a CSV file stored in a determination result storage unit of the repair person terminal.

FIG. 10 is a flowchart showing an example of a main procedure of information processing executed by a processor of the MFP.

FIG. 11 shows a first part of a flowchart showing an example of a main procedure of information processing executed by the processor of the repair person terminal in a modified example.

### DETAILED DESCRIPTION

A challenge to be solved by the present disclosure is to provide a firmware package creation apparatus, a firmware package creation program, and a firmware update system that can create a firmware package adaptable to a plurality of types of devices even if firmware data is individually created with respect to each of the plurality of types of devices.

In general, according to one embodiment, a firmware package creation apparatus includes a processor and a storage device, and creates a firmware package containing a plurality of pieces of firmware data for a plurality of types of devices. The storage device stores a plurality of pieces of firmware data by type for the plurality of types of devices. The processor classifies a plurality of files contained in the firmware data by type as common files used in common in all types and files by device used only in a type as a target of the firmware data by type with respect to each of the plurality of pieces of firmware data by type, creates a first compressed file by collectively compressing only the common files from the plurality of pieces of firmware data by type based on the classification, creates a second compressed file by collectively compressing only the files by device with respect to each of the plurality of pieces of firmware data by type for all of the plurality of pieces of firmware data by type, and thereby, creates a plurality of the second compressed files. Further, the processor creates one firmware package by collectively compressing the first compressed file and the plurality of second compressed files.

As below, an embodiment will be explained with a case where a plurality of types of devices are MFPs of different models from the same manufacturer as well as devices from different manufacturers installed in a workplace as an example. Obviously, the devices are not limited to the MFPs.

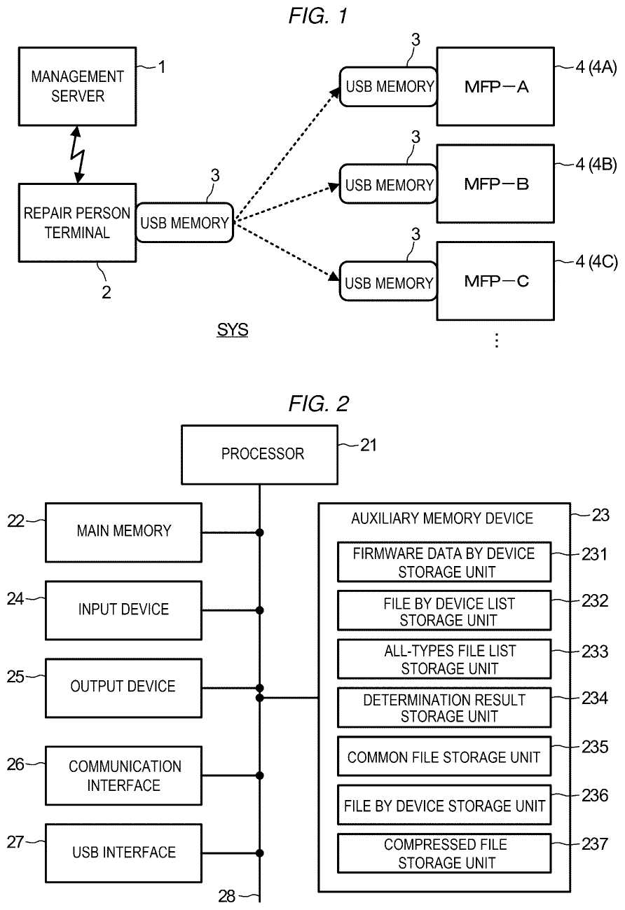

FIG. 1 is a diagram for explanation of an example of a configuration of a firmware update system SYS according to the embodiment. The firmware update system SYS includes a management server 1, a repair person terminal 2, a USB memory 3, MFPs 4A, 4B, 4C, . . . . In the following description, if distinctions among the MFPs 4A, 4B, 4C, . . . are not particularly necessary, the MFPs are collectively simply referred to as MFPs 4. The repair person terminal 2 is an example of a firmware package creation apparatus according to the embodiment. In FIG. 1, the MFPs 4 include the MFP 4A of a type A shown by MFP-A, the MFP 4B of a type B shown by MFP-B, the MFP 4C of a type C shown by MFP-C, . . . , however, the number of the MFPs is any number more than one. In FIG. 1, only one repair person terminal 2 is shown, however, the firmware update system SYS may include more. Also, the firmware update system SYS may include a plurality of the management servers 1.

The management server 1 is a server administered by e.g., a manufacturer of the MFPs 4 configured in a cloud. The management server 1 provides firmware data by type as firmware data with respect to each of the plurality of types of MFPs 4 as products of the manufacturer.

The repair person terminal 2 is a personal computer used by a repair person or the like. The repair person terminal 2 communicates with the management server 1 and acquires desired firmware data by type for a plurality of types of devices. The repair person terminal 2 classifies files from a plurality of pieces of firmware data by type as common files used in common in all types and files by device used only in a type as a target of each firmware data by type. Then, the repair person terminal 2 creates a first compressed file by collectively compressing only the common files and creates a second compressed file by collectively compressing only the files by device with respect to each of the plurality of pieces of firmware data by type for all of the plurality of pieces of firmware data by type, and thereby, creates a plurality of the second compressed files based on the classification. The repair person terminal 2 creates one firmware package by collectively compressing the first compressed file and the plurality of second compressed files.

The USB memory 3 is an example of an external storage medium detachable from the repair person terminal 2 and the MFPs 4. The firmware package created by the repair person terminal 2 is stored in the USB memory 3. The repair person brings the USB memory 3 and visits a customer's place using the MFPs 4. Then, the USB memory 3 is connected to the MFP 4 to be updated with firmware data.

The MFP 4 decompresses the firmware package stored in the connected USB memory 3 and acquires the first compressed file and the plurality of second compressed files. The MFP 4 decompresses the first compressed file and obtains the common files and decompresses the second compressed file corresponding to the type of the device from the plurality of second compressed files and obtains the files by device for the device. Then, the MFP 4 collects the common files and the files by device for the device and restores the firmware data by type for the device, and updates the previously stored firmware data by applying the data.

FIG. 2 is a diagram for explanation of an example of a configuration of the repair person terminal 2. As shown in FIG. 2, the repair person terminal 2 includes a processor 21, a main memory 22, an auxiliary memory device 23, an input device 24, an output device 25, a communication interface 26, a USB interface 27, and a system transmission line 28. The system transmission line 28 includes an address bus, a data bus, a control signal line, etc. The system transmission line 28 connects the processor 21 and other respective units directly or via a signal input/output circuit, and transmits data signals to be transmitted and received therebetween. The processor 21, the main memory 22, and the auxiliary memory device 23 are connected by the system transmission line 28, and thereby, a computer of the repair person terminal 2 is formed.

The processor 21 corresponds to a center part of the computer. The processor 21 controls the respective units for implementing various functions as the repair person terminal 2 according to an operating system or a control program. The processor 21 is e.g., a CPU (Central Processing Unit). The processor 21 may be a multi-core/multi-thread processor and may execute a plurality of pieces of processing in parallel. The processor 21 may be e.g., an MPU (Micro Processing Unit), an SoC (System on a Chip), a DSP (Digital Signal Processor), a GPU (Graphics Processing Unit), an ASIC (Application Specific Integrated Circuit), a PLD (Programmable Logic Device), an FPGA (Field-Programmable Gate Array), or the like. Alternatively, the processor 21 may be a combination of processors thereof.

The main memory 22 corresponds to a main memory part of the computer. The main memory 22 includes a non-volatile memory area and a volatile memory area. The main memory 22 stores firmware data such as BIOS executed by the processor 21 prior to the operating system in the non-volatile memory area. The main memory 22 stores the operating system and control programs and data necessary for the processor 21 to execute processing for controlling the respective units in the non-volatile or volatile memory area. The main memory 22 uses the volatile memory area as a work area in which data is appropriately rewritten by the processor 21. The non-volatile memory area is e.g., a ROM (Read Only Memory) or an EEPROM (registered trademark) (Electric Erasable Programmable Read-Only Memory). The volatile memory area is e.g., a RAM (Random Access Memory).

The auxiliary memory device 23 corresponds to an auxiliary memory part of the computer. For example, an EEPROM, an HDD (Hard Disc Drive), or an SSD (Solid State Drive) may be the auxiliary memory device 23. The auxiliary memory device 23 stores data used by the processor 21 performing various kinds of processing, data created by processing in the processor 21, etc. For example, the memory area of the auxiliary memory device 23 may include a firmware data by device storage unit 231, a file by device list storage unit 232, an all-types file list storage unit 233, a determination result storage unit 234, a common file storage unit 235, a file by device storage unit 236, and a compressed file storage unit 237. For example, one directory in the memory area of the auxiliary memory device 23 is assigned to each of these storage units 231 to 237. Note that, in FIG. 2 and other drawings, which will be described later, firmware may be abbreviated as FW due to limitations of space. The auxiliary memory device 23 may store the control program.

The firmware data by device storage unit 231 stores the plurality of pieces of firmware data by type for the plurality of types of MFPs 4 acquired from the management server 1.

The file by device list storage unit 232 stores a list of files contained in the firmware data by type with respect to each firmware data by type stored in the firmware data by device storage unit 231.

The all-types file list storage unit 233 stores a list formed by deduplication and merge of the lists of the files stored in the file by device list storage unit 232.

The determination result storage unit 234 stores a CSV (comma Separated Values) file in which a determination result as to whether the file is the common file or the file by device with respect to each file in the list stored in the all-types file list storage unit 233.

The common file storage unit 235 stores the file as the common file in the determination result recorded in the CSV file of the determination result storage unit 234 of the files contained in the plurality of pieces of firmware data by type stored in the firmware data by device storage unit 231.

The file by device storage unit 236 stores the file as the file by device in the determination result recorded in the CSV file of the determination result storage unit 234 of the files contained in the plurality of pieces of firmware data by type stored in the firmware data by device storage unit 231.

The compressed file storage unit 237 stores the first compressed file formed by compression of the files stored in the common file storage unit 235 and the plurality of second compressed files formed by compression of the files stored in the file by device storage unit 236 by device. Further, the compressed file storage unit 237 stores one firmware package formed by collective compression of the first compressed file and the plurality of second compressed files.

The input device 24 is an input device such as a keyboard or a pointing device. Note that the repair person terminal 2 may include an input interface for connection of a keyboard or a pointing device in place of the input device 24.

The output device 25 is a display device such as a liquid crystal display or an organic EL display. Note that the repair person terminal 2 may include an output interface for connection of an external display device in place of the output device 25. Note that the input device 24 and the output device 25 may be e.g., a touch panel in which a display device such as a liquid crystal display or an organic EL display and a pointing device by touch input are stacked.

The communication interface 26 performs data communication according to a preset communication protocol between an external apparatus connected via a communication network such as the Internet and itself. The external apparatus is e.g., the management server 1 or the like.

Various USB devices are connected to the USB interface 27 via USB ports (not shown) and data is transmitted to and received from the connected USB devices. For example, the USB memory 3 is connected to the USB interface 27, and the USB interface 27 writes data in the connected USB memory 3 and reads data from the USB memory 3. The USB interface 27 is an example of an interface with an external storage medium. Further, a USB input device such as a USB keyboard or a USB mouse may be connected to the USB interface 27.

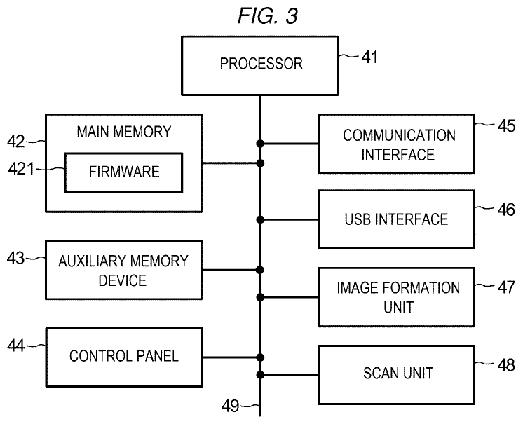

FIG. 3 is a diagram for explanation of an example of a configuration of the MFP 4 as a device included in the firmware update system SYS. As shown in FIG. 3, the MFP 4 includes a processor 41, a main memory 42, an auxiliary memory device 43, a control panel 44, a communication interface 45, a USB interface 46, an image formation unit 47, a scan unit 48, and a system transmission line 49. The system transmission line 49 includes an address bus, a data bus, a control signal line, etc. The system transmission line 49 connects the processor 41 and other respective units directly or via a signal input/output circuit, and transmits data signals to be transmitted and received therebetween. The processor 41, the main memory 42, and the auxiliary memory device 43 are connected by the system transmission line 49, and thereby, a computer of the MFP 4 is formed.

The processor 41 corresponds to a center part of the computer. The processor 41 controls the respective units for implementing various functions as the MFP 4 according to an operating system or a control program. The processor 41 is e.g., a CPU. The processor 41 may be a multi-core/multi-thread processor and may execute a plurality of pieces of processing in parallel. The processor 41 may be e.g., an MPU, an SoC, a DSP, a GPU, an ASIC, a PLD, an FPGA, or the like. Alternatively, the processor 41 may be a combination of processors thereof.

The main memory 42 corresponds to a main memory part of the computer. The main memory 42 includes a non-volatile memory area and a volatile memory area. The main memory 42 stores firmware data 421 such as BIOS executed by the processor 41 prior to the operating system in the non-volatile memory area. The main memory 42 stores the operating system and control programs and data necessary for the processor 41 to execute processing for controlling the respective units in the non-volatile or volatile memory area. The main memory 42 uses the volatile memory area as a work area in which data is appropriately rewritten by the processor 41. The non-volatile memory area is e.g., a ROM or an EEPROM. The volatile memory area is e.g., a RAM.

The auxiliary memory device 43 corresponds to an auxiliary memory part of the computer. For example, an EEPROM, an HDD, or an SSD may be the auxiliary memory device 43. The auxiliary memory device 43 stores data used by the processor 41 performing various kinds of processing, data created by processing in the processor 41, etc. The auxiliary memory device 43 may store the control program.

The control panel 44 functions as a user interface and includes a button and a touch panel for an operator of the MFP 4 to operate. For example, the touch panel is e.g., a panel in which a display device such as a liquid crystal display or an organic EL display and a pointing device by touch input are stacked. Therefore, the button and the touch panel function as input devices receiving an operation by the operator of the MFP 4. Further, the display of the touch panel functions as a display device that notifies the operator of the MFP 4 of various kinds of information.

The communication interface 45 communicates with a user terminal such as a personal computer and receives printing data for image formation via wired or wireless connection. Further, the communication interface 45 may perform data communication according to a preset communication protocol between an external apparatus connected via a communication network such as the Internet and itself. The external apparatus is e.g., the repair person terminal 2 or the like.

For example, the USB memory 3 is connected to the USB interface 46 via a USB port (not shown), and the interface writes data in the connected USB memory 3 and reads data from the USB memory 3. The USB interface 46 is an example of an interface with an external storage medium.

The image formation unit 47 prints an image by e.g., electrophotography. That is, the image formation unit 47 forms an image using toner on an image formation medium or the like. The image formation medium is e.g., a sheet of paper.

The scan unit 48 reads an image from a document with the image formed thereon or the like. For example, the MFP 4 prints the image read from the document or the like using the scan unit 48 on the image formation medium using the image formation unit 47, and thereby, implements a document copy.

As below, an operation of the firmware update system SYS having the above described configuration will be explained.

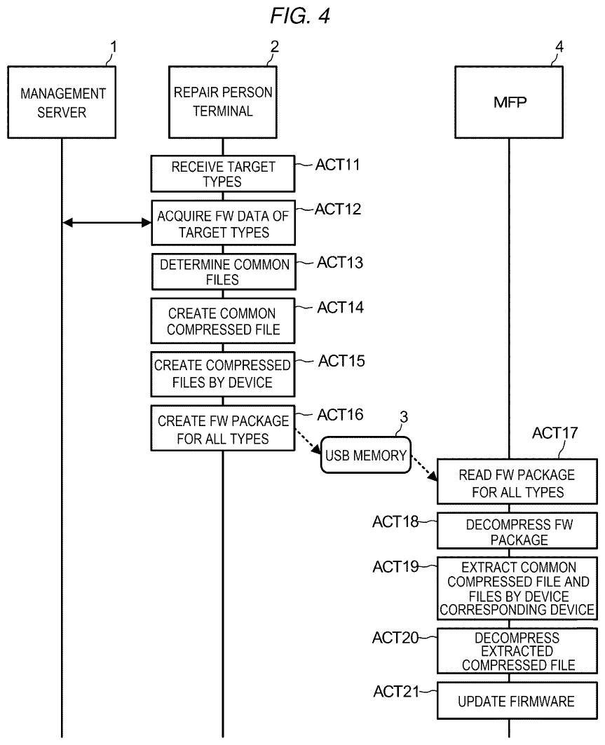

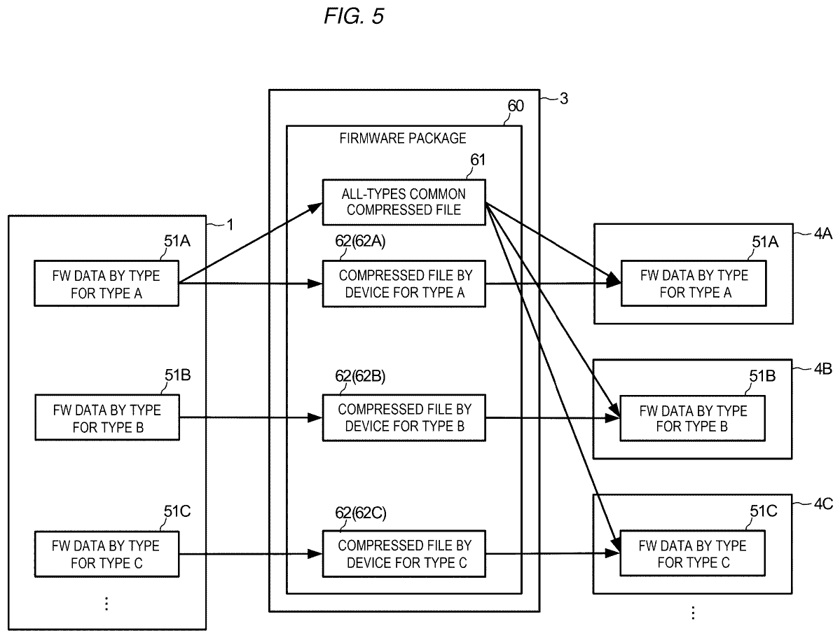

FIG. 4 is a sequence chart for explanation of the operation of the firmware update system SYS. Further, FIG. 5 is a diagram for explanation of a relationship between firmware data by type and a firmware package for all types.

As shown in FIG. 4, the repair person terminal 2 receives designation of MFPs 4 as targets, i.e., a plurality of types of MFPs 4 desired to be stored in the USB memory 3 and brought out by the repair person operating the input device 24 (ACT 11).

If the repair person terminal 2 receives the designation, the terminal acquires latest firmware data by type for the corresponding types of MFPs 4 from the management server 1 (ACT 12). For example, as shown in FIG. 5, when firmware data by type 51A for type A, firmware data by type 51B for type B, firmware data by type 51C for type C, . . . are stored in the management server 1, if the repair person designates three types A, B, C of the types, the repair person terminal 2 acquires the firmware data by type 51A, 51B, 51C for the corresponding types.

The repair person terminal 2 determines the common files contained in common in the acquired plurality of pieces of firmware data by type (ACT 13). The determination is performed by e.g., hash check. More specifically, a hash value in MD 5 algorithm of each file is calculated and the respective hash values are compared. The repair person terminal 2 determines that the files are the common files if the hash values are the same in all of the plurality of pieces of firmware data by type. The files contained in each firmware data by type except the common files are the files by device used only in the type as a target of the firmware data by type.

The repair person terminal 2 compresses the common files and creates an all-types common compressed file 61 to be stored in the USB memory 3 as shown in FIG. 5 (ACT 14). The all-types common compressed file 61 is an example of the first compressed file created by collective compression of only the common files used in common in all types from the plurality of pieces of firmware data by type.

Further, the repair person terminal 2 creates compressed files by device for each device by compression of the files except the common files with respect to each of the plurality of pieces of firmware data by type (ACT 15). Thereby, as shown in FIG. 5, a compressed file by device for type A 62A, a compressed file by device for type B 62B, a compressed file by device for type C 62C are created. In the following description, distinctions among the compressed file by device for type A 62A, the compressed file by device for type B 62B, the compressed file by device for type C 62C are not particularly necessary, the files are collectively simply referred to as compressed files by device 62. These plurality of compressed files by device 62 are examples of a second compressed file created by collective compression only the files by device with respect to each of the plurality of pieces of firmware data by type.

The repair person terminal 2 further compresses the created all-types common compressed file 61 and the plurality of compressed files by device 62 to create one compressed file, and thereby, creates a firmware package 60 for all types (ACT 16).

The repair person records the created firmware package in the USB memory 3, and carries the memory and visits a customer's place. Then, the repair person connects the USB memory 3 to the MFP 4 to be updated with the firmware data and commands firmware update.

In response to the command of firmware update, the MFP 4 reads the firmware package 60 for all types from the connected USB memory 3 (ACT 17).

The MFP 4 decompresses the firmware package 60 and restores the all-types common compressed file 61 and the plurality of compressed files by device 62 (ACT 18).

The MFP 4 extracts the all-types common compressed file 61 and the compressed files by device 62 corresponding to the device from the restored compressed flies (ACT 19).

Then, the MFP 4 decompresses these extracted all-types common compressed file 61 and compressed files by device 62 and restores the firmware data by type corresponding to the device (ACT 20).

In this manner, as shown in FIG. 5, the MFP 4, e.g., the MFP 4A of type A acquires firmware data for the device, i.e., firmware data by type 51A for type A from the all-types common compressed file 61 and the compressed file by device for type A 62A contained in the firmware package 60.

Then, the MFP 4 may update the firmware data 421 stored in the main memory 42 by the acquired firmware data by type for the device (ACT 21).

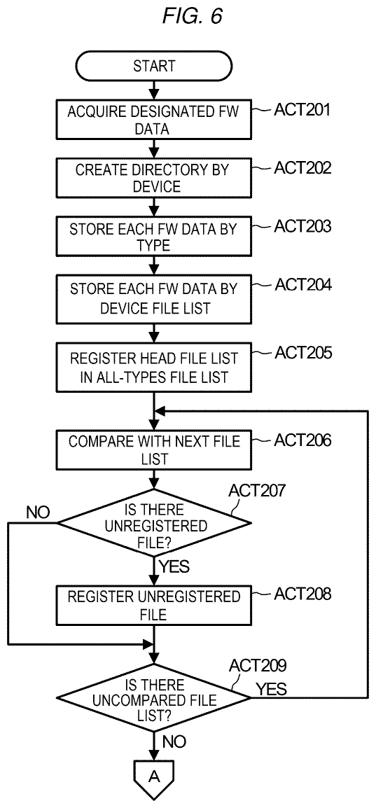

As below, an operation of the repair person terminal 2 for implementing the above described actions will be explained. FIGS. 6 to 8 are a series of flowcharts showing an example of a main procedure of information processing executed by the processor 21 of the repair person terminal 2 for execution of a firmware package creation program as a control program. FIGS. 6 to 8 show the procedures of the information processing after the designation of the target device is received. Note that, unless otherwise described, a processing operation of the processor 21 shown in FIGS. 6 to 8 shifts after ACT n (n is a natural number) to ACT (n+1). Further, the procedure shown in FIGS. 6 to 8 is an example. the procedure is not particularly limited as long as the equal result is obtained.

As shown in FIG. 6, as ACT 201, the processor 21 acquires latest firmware data by type for all MFPs 4 designated as target devices by an operation of the input device 24 by the repair person from the management server 1 via a network by the communication interface 26.

As ACT 202, the processor 21 creates a directory as a storage part for storage of the acquired firmware data by type in the firmware data by device storage unit 231 of the auxiliary memory device 23 according to the acquired firmware data by type. If the firmware data by device storage unit 231 is prepared as one directory of the auxiliary memory device 23, e.g., an HDD or the like, the directory for each firmware data by type is a sub-directory of the directory as the firmware data by device storage unit 231. Note that, for which device the firmware data by type is acquired is known by the previous designation, and the order of ACT 201 and ACT 202 may be reversed.

As ACT 203, the processor 21 stores each of the acquired firmware data by type in the corresponding directory of the firmware data by device storage unit 231. Note that, if the acquired firmware data by type is provided as a compressed file, the processor 21 decompresses the compressed file and stores the decompressed firmware data by type in the firmware data by device storage unit 231. Thereby, the firmware data by type for the respective devices is stored in different directories by device.

As ACT 204, the processor 21 stores a file list of each firmware data by type, for example, in the file by device list storage unit 232 prepared as one directory of the auxiliary memory device 23. Specifically, the processor 21 confirms the files contained in the firmware data by type with respect to each of the plurality of pieces of firmware data by type stored in the firmware data by device storage unit 231, and creates a file list describing at least file names of the respective files and directories as storage destinations. The file list may be described in a form of a file path connecting the directory and the file name. Note that the file name in the embodiment may include a file extension. Thereby, the respective file lists of the firmware data by type for the respective devices are individually stored in the file by device list storage unit 232.

As ACT 205, the processor 21 registers one of the plurality of file lists stored in the file by device list storage unit 232, e.g., the file list at the head in the order of storage or the order of names as an all-types file list, for example, in the all-types file list storage unit 233 prepared as one directory of the auxiliary memory device 23. That is, the processor 21 copies the file list in the all-types file list storage unit 233 and renames the file name as the all-types file list.

As ACT 206, the processor 21 compares the next file list of the plurality of file lists stored in the file by device list storage unit 232 with the all-types file list registered in the all-types file list storage unit 233.

As ACT 207, the processor 21 determines whether there is an unregistered file in the all-types file list, that is, whether there is a file not registered in the all-types file list of the files described in the next file list. If there is no unregistered file, the processor 21 determines as NO in ACT 207 and shifts to processing in ACT 209. If there is an unregistered file, the processor 21 determines as YES in ACT 207 and shifts to processing in ACT 208.

As ACT 208, the processor 21 additionally registers the unregistered file in the all-types file list.

As ACT 209, the processor 21 determines whether there is a file list not yet compared in the plurality of file lists stored in the file by device list storage unit 232. If there is an uncompared file list, the processor 21 determines as YES in ACT 209 and shifts to processing in ACT 206. If there is no uncompared file list, the processor 21 determines as NO in ACT 209 and shifts to processing in ACT 210.

The above described ACT 201 to ACT 209 are creation processing of a file list executed as preprocessing. Then, the processor 21 executes file preparation processing for preparing files to be contained in the firmware package based on the created file list.

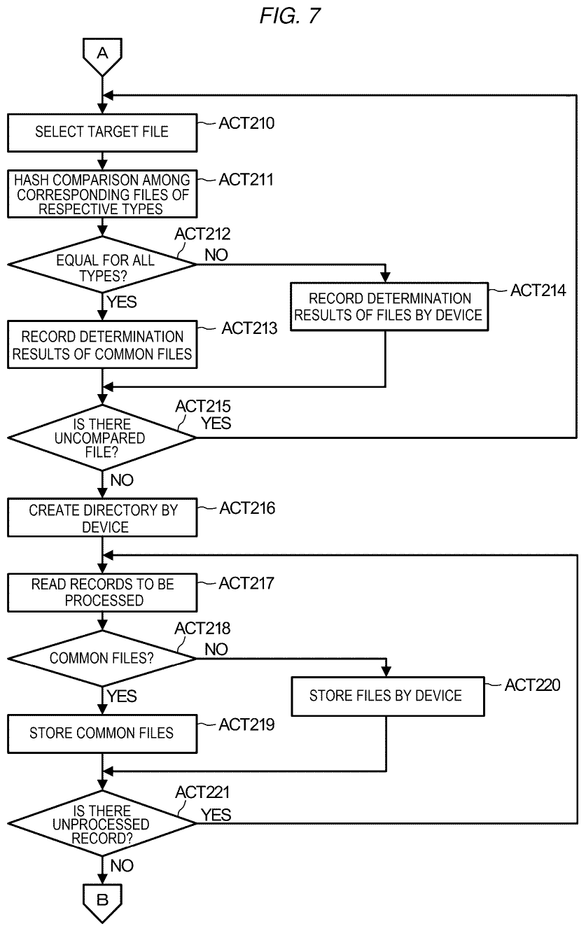

As shown in FIG. 7, as ACT 210, the processor 21 selects the files from the head of the plurality of files described in the all-types file list stored in the all-types file list storage unit 233 of the auxiliary memory device 23 as files to be processed.

As ACT 211, the processor 21 performs hash comparison between the files having the same file name as the file selected as the file to be processed of the files contained in each of the plurality of pieces of firmware data by type stored in the firmware data by device storage unit 231.

As ACT 212, the processor 21 determines whether hash values are equal in all of the plurality of pieces of firmware data by type. If the hash values are equal in not all firmware data by type, the processor 21 determines as NO in ACT 212 and shifts to processing in ACT 214. If the hash values are equal in all firmware data by type, the processor 21 determines as YES in ACT 212 and shifts to processing in ACT 213.

As ACT 213, the processor 21 records a determination result that the file having the file name is a common file, for example, in the CSV file of the determination result storage unit 234 prepared as one directory of the auxiliary memory device 23. Note that the determination result storage unit 234 may be the same directory as that of the other storage unit. Then, the processor 21 shifts to processing in ACT 215.

As ACT 214, the processor 21 records a determination result that the file having the file name is a file by device in the CSV file of the determination result storage unit 234.

FIG. 9 is a diagram for explanation of an example of a record structure of the CSV file stored in the determination result storage unit 234. As shown in FIG. 9, a record of the CSV file contains items of the file name of the file, the storage directory in which the file is stored, and the determination result. Note that, for the common file, the storage directory may be a directory of any one of the plurality of pieces of firmware data by type in the firmware data by device storage unit 231. In the embodiment, the storage directory is a directory of the firmware data by type corresponding to the file list at the head of the plurality of file lists stored in the file by device list storage unit 232.

As ACT 215, the processor 21 determines whether there is an uncompared file for which hash comparison is not performed. That is, the processor 21 determines whether all of the plurality of files described in the all-types file list stored in the all-types file list storage unit 233 are selected as files to be processed. If there is an uncompared file, the processor 21 determines as YES in ACT 215 and shifts to processing in ACT 210. If there is no uncompared file, the processor 21 determines as NO in ACT 215 and shifts to processing in ACT 216.

Through the above described processing in ACT 210 to ACT 215, the files contained in the plurality of pieces of firmware data by type are classified as common files and files by device.

As ACT 216, the processor 21 creates directories by device as storage parts for storage of the files by device in the file by device storage unit 236 of the auxiliary memory device 23 by device. For example, if the file by device storage unit 236 is prepared as one directory, each directory by device is a sub-directory of the directory as the file by device storage unit 236.

As ACT 217, the processor 21 selects records sequentially from the head record of the CSV file stored in the determination result storage unit 234 as records to be processed and reads determination results in the records.

As ACT 218, the processor determines whether the read determination result is a common file. If the determination result is not a common file, the processor 21 determines as NO in ACT 218 and shifts to processing in ACT 220. If the determination result is a common file, the processor 21 determines as YES in ACT 218 and shifts to processing in ACT 219.

As ACT 219, the processor 21 stores the file of the firmware data by type stored in the firmware data by device storage unit 231 specified by the file name and the storage directory of the record to be processed, for example, in the common file storage unit 235 prepared as one directory of the auxiliary memory device 23. Then, the processor 21 shifts to processing in ACT 221.

As ACT 220, the processor 21 stores the file of the firmware data by type stored in the firmware data by device storage unit 231 specified by the file name and the storage directory of the record to be processed in the directory by device corresponding to the storage directory created in the file by device storage unit 236 as the file by device.

As ACT 221, the processor 21 determines whether there is an unprocessed record in the CSV file of the determination result storage unit 234. That is, the processor 21 determines whether all of the plurality of records recorded in the CSV file are selected as records to be processed. If there is an unprocessed record, the processor 21 determines as YES in ACT 221 and shifts to processing in ACT 217. If there is no unprocessed record, the processor 21 determines as NO in ACT 221 and shifts to processing in ACT 222.

If the files to be contained in the firmware package is prepared as in the above described ACT 210 to ACT 221, the processor 21 executes package creation processing of creating a firmware package from those files.

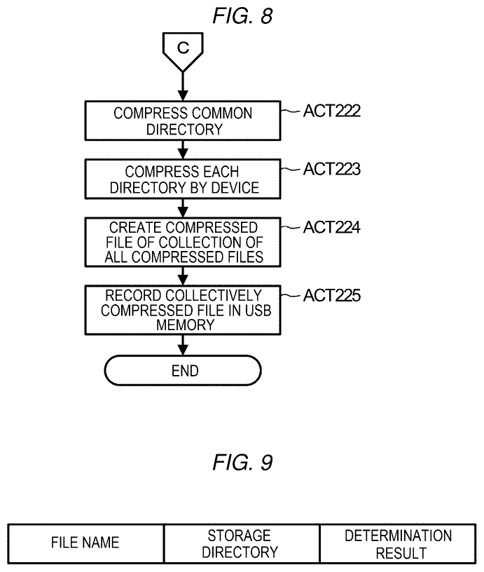

As shown in FIG. 8, as ACT 222, the processor 21 executes compression processing of compressing a common directory as a directory of the common file storage unit 235. Thereby, the plurality of common files stored in the common directory are compressed as one compressed file and the all-types common compressed file 61 is created. The created all-types common compressed file 61 is stored, for example, in the compressed file storage unit 237 prepared as one directory of the auxiliary memory device 23.

As ACT 223, the processor 21 executes compression processing of compressing each of the plurality of directories by device respectively formed as individual directories in the file by device storage unit 236. Thereby, the plurality of common files stored in each directory by device are compressed as one compressed file and a compressed file by device 62 for each type is created. The created plurality of compressed files by device 62 are stored in the compressed file storage unit 237.

As ACT 224, the processor 21 executes compression processing of compressing the directory of the compressed file storage unit 237, and thereby, creates a compressed file formed by collection of all compressed files stored in the compressed file storage unit 237.

As ACT 225, the processor 21 stores the created compressed file formed by collection of all compressed files as the firmware package for all types in the USB memory 3 via the USB interface 27.

Then, though not particularly illustrated, the processor 21 deletes the contents of the firmware data by device storage unit 231, the file by device list storage unit 232, the all-types file list storage unit 233, the determination result storage unit 234, the common file storage unit 235, the file by device storage unit 236, and the compressed file storage unit 237 and ends the processing.

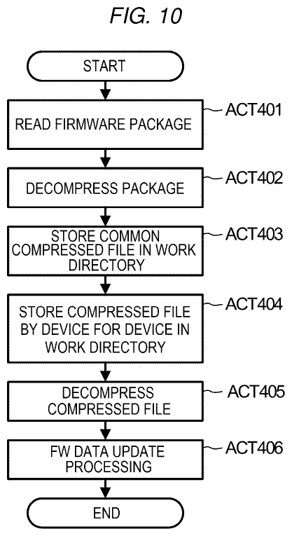

Next, an operation of the MFP 4 will be explained. FIG. 10 is a flowchart showing an example of a main procedure of information processing executed by the processor 41 of the MFP 4. FIG. 10 shows a procedure of information processing if the USB memory 3 is connected to the USB port (not shown) and the repair person inputs a predetermined firmware update command using the control panel 44. Note that the procedure shown in FIG. 10 is an example and the procedure is not particularly limited as long as the same result is obtained.

As ACT 401, the processor 41 reads the firmware package 60 for all types from the USB memory 3 via the USB interface 46 and stores the package in one temporary storage directory prepared in the auxiliary memory device 43.

As ACT 402, the processor 41 decompresses the firmware package 60 for all types stored in the temporary storage directory, and thereby, restores the all-types common compressed file 61 and the compressed files by device 62 for plurality of types.

As ACT 403, the processor 41 stores the restored all-types common compressed file 61 in one work directory prepared in the auxiliary memory device 43. The storage processing may be copying the restored all-types common compressed file 61 from the temporary storage directory to the work directory or moving the file to the work directory.

As ACT 404, the processor 41 stores the compressed file by device 62 for the device in the work directory in which the all-types common compressed file 61 is stored from the restored compressed files by device 62 for plurality of types. The storage processing may be copying or moving.

As ACT 405, the processor 41 decompresses the two compressed files of the all-types common compressed file 61 and the compressed file by device 62 for the device in the work directory. Thereby, the firmware data by type corresponding to the device is restored.

Accordingly, as ACT 406, firmware data update processing of updating the firmware data 421 stored in the main memory 42 is executed using the firmware data by type restored in the work directory.

Then, though not particularly illustrated, the processor 41 deletes the contents of the temporary storage directory and the work directory and ends the processing.

As described above, the repair person terminal 2 as an example of the firmware package creation apparatus according to the embodiment includes the processor 21 and the auxiliary memory device 23 as an example of a storage device, and creates the firmware package containing the plurality of pieces of firmware data for the MFPs 4 as an example of the plurality of types of devices, and the auxiliary memory device 23 stores the plurality of pieces of firmware data by type 51A, 51B, 51C, . . . for the plurality of types of MFPs 4A, 4B, 4C, . . . in the firmware data by device storage unit 231. The processor 21 classifies the plurality of files contained in the firmware data by type as the common files used in common in all types and the files by device used only in a type as a target of the firmware data by type with respect to each of the plurality of pieces of firmware data by type, creates the all-types common compressed file 61 as an example of the first compressed file by collectively compressing only the common files from the plurality of pieces of firmware data by type, creates the compressed file by device 62 as an example of the second compressed file by collectively compressing only the files by device with respect to each of the plurality of pieces of firmware data by type for all of the plurality of pieces of firmware data by type, and thereby, creates the plurality of the compressed files by device 62, for example, the compressed file by device for type A 62A, the compressed file by device for type B 62B, and the compressed file by device for type C 62C based on the classification. Then, the processor 21 creates one firmware package 60 by collectively compressing the all-types common compressed file 61 and the plurality of compressed files by device 62.

Therefore, according to the embodiment, even if firmware data is individually created with respect to each of the plurality of types devices such as MFPs 4, a firmware package adaptable to the plurality of types of devices can be created.

In related art, there is one kind of firmware data for one type of types in the market, and management of the one kind of firmware data for one type requires time and effort and capacity of the size of the firmware data to be managed is large. Accordingly, in the embodiment, when the firmware data is created, the respective files contained in the firmware data by type are classified as common files among types and uncommon files among types, the firmware data by device is divided into a common part among types and uncommon parts among types for each type, and the respective parts are provided as single compressed files. Thereby, the capacity for the duplicated parts in common with the firmware data for the plurality of types may be reduced and the firmware data for the plurality of types can be provided in small capacity. In addition, in the embodiment, the plurality of pieces of firmware data by type are provided as one firmware package and easily managed.

Note that, according to the embodiment, the processor 21 performs the classification of common files among types and uncommon files among types by hash comparison between the files having same file names contained in the plurality of pieces of firmware data by type.

Therefore, by hash comparison, whether the files are duplicated files may be easily determined and the common files among types and the uncommon files among types may be classified.

Particularly, according to the embodiment, of the plurality of files having the same file names contained in the plurality of pieces of firmware data by type, even if one type has a different hash, the processor 21 classifies the files as the files by device in all types.

Therefore, the common files among types and the uncommon files among types may be reliably classified.

Further, according to the embodiment, the processor 21 creates a file list of files contained in the plurality of pieces of firmware data by type except the same file names in the all-types file list storage unit 233 of the auxiliary memory device 23 as an example of the storage device, and performs the hash comparison of the files described in the file list one by one.

Therefore, all files contained in the plurality of pieces of firmware data by type are registered in the file list and hash comparison is performed, and every file can be reliably classified.

The repair person terminal 2 includes the USB interface 27 as an example of an interface with the USB memory 3 as an example of an external storage medium detachable from the terminal, and the processor 21 stores the created firmware package in the USB memory 3 via the USB interface 27.

Therefore, the firmware package can be easily brought out.

The firmware update system SYS according to the embodiment includes the repair person terminal 2 as an example of the firmware package creation apparatus and the plurality of MFPs 4 as an example of a plurality of types of devices each including the processor 41 and the auxiliary memory device 43 as an example of the storage device and updating firmware data using the firmware package created by the repair person terminal 2. The processor 41 of the MFP 4 decompresses the firmware package and stores the all-types common compressed file 61 as an example of the first compressed file and the plurality of compressed files by device 62 as the plurality of second compressed files in the auxiliary memory device 43, restores the firmware data by type of the device by decompressing the all-types common compressed file 61 and the compressed file by device 62 corresponding to the device from the plurality of compressed files by device 62. The processor 41 of the MFP 4 applies the restored firmware data by type, and thereby, updates the firmware data 421 stored in the main memory 42.

Therefore, according to the embodiment, even if firmware data is individually created with respect to each of the plurality of types of the devices such as MFPs 4, a firmware package adaptable to the plurality of types of devices can be created and, in each device, the firmware data corresponding to the device can be restored from the firmware package and the firmware data can be updated.

### MODIFIED EXAMPLE

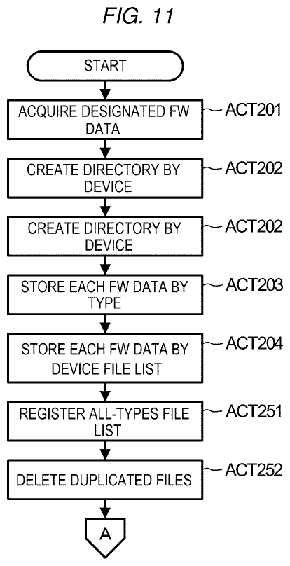

FIG. 11 shows a first part of a flowchart showing an example of a main procedure of information processing executed by the processor 21 of the repair person terminal 2 in a modified example. The second part and the third part are as described in the embodiment. As shown in FIG. 11, in the modified example, the processing in ACT 205 to ACT 209 of the embodiment is changed to processing in ACT 251 and ACT 252.

That is, as ACT 251, the processor 21 registers contents of the plurality of file lists stored in the file by device list storage unit 232 as an all-types file list in the all-types file list storage unit 233. Specifically, the processor 21 reads the plurality of file lists stored in the file by device list storage unit 232 one by one sequentially from the head and additionally registers the contents thereof in the all-types file list provided in the all-types file list storage unit 233.

As ACT 252, if there are duplicated files in the files registered in the all-types file list registered in the all-types file list storage unit 233, the processor 21 deletes the other duplicated files but one.

Even if the creation processing of the file list executed as preprocessing is performed in the above described manner, like the embodiment, a file list of files contained in the plurality of pieces of firmware data by type except the same file names is created in the all-types file list storage unit 233.

Note that, in the above described embodiment, the firmware package creation program as the control program executed by the processor 21 of the repair person terminal 2 as an example of the firmware package creation apparatus may be recorded in a computer-readable storage medium such as a CD-ROM and provided. Further, the control program may be stored in a computer connected to a network such as the Internet and downloaded and provided via the network.

Further, the firmware package created in the repair person terminal 2 is provided to the MFP 4 as an example of the device to be updated with firmware data via the USB memory 3, however, the firmware package may be transmitted from the communication interface 26 of the repair person terminal 2 to the communication interface 45 of the MFP 4 via a communication network. Or, the firmware package may be transmitted not via direct communication between the interfaces, but once via a file server or the like in a cloud.

Further, a firmware package may be created in the management server 1 by provision of the function of the firmware package creation apparatus to the management server 1 and designation of a plurality of types of devices to be brought from the repair person terminal 2, and the created firmware package may be downloaded and used in the repair person terminal 2 or the MFP 4.

The above described flows of the information processing performed by the processors 21 and 41 explained with reference to the flowcharts are an example and not limited to the orders. For example, as described above, the order of ACT 201 and ACT 202 may be reversed or performed in parallel. As long as the consistency with the precedent or subsequent processing is maintained, the order of the processing may be changed or a plurality of pieces of processing may be performed in parallel.

In the above described embodiment, the firmware data by device storage unit 231, the file by device list storage unit 232, the all-types file list storage unit 233, the determination result storage unit 234, the common file storage unit 235, the file by device storage unit 236, and the compressed file storage unit 237 are provided in the auxiliary memory device 23, however, obviously, one or more of the units may be provided in the main memory 22.

Note that the functions explained in the above described respective embodiments are not only configured using hardware. A program describing the respective functions may be read and implemented by a computer using software. Further, one of software or hardware may be appropriately selected to configure each function.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A firmware package creation apparatus creating a firmware package containing a plurality of pieces of firmware data for a plurality of types of devices, the apparatus comprising:
a processor; and
a storage device,
the storage device storing a plurality of pieces of firmware data by type for the plurality of types of devices,
the processor classifying a plurality of files contained in the firmware data by type as common files used in common in all types and files by device used only in a type as a target of the firmware data by type with respect to each of the plurality of pieces of firmware data by type,
the processor creating a first compressed file by collectively compressing only the common files from the plurality of pieces of firmware data by type based on the classification,
the processor creating a second compressed file by collectively compressing only the files by device with respect to each of the plurality of pieces of firmware data by type for all of the plurality of pieces of firmware data by type, and thereby, creating a plurality of the second compressed files based on the classification, and
the processor creating the firmware package by collectively compressing the first compressed file and the plurality of second compressed files.

2. The firmware package creation apparatus according to claim 1, wherein
the processor performs the classification by hash comparison between the files having same file names contained in the plurality of pieces of firmware data by type.

3. The firmware package creation apparatus according to claim 2, wherein
of the plurality of files having the same file names contained in the plurality of pieces of firmware data by type, even if one type has a different hash, the processor classifies the files as the files by device in all types.

4. The firmware package creation apparatus according to claim 2, wherein
the processor creates a file list of files contained in the plurality of pieces of firmware data by type except the same file names in the storage device, and performs the hash comparison of the files described in the file list one by one.

5. The firmware package creation apparatus according to claim 1, further comprising an interface with an external storage medium detachable from the firmware package creation apparatus, wherein
the processor stores the created firmware package in the external storage medium via the interface.

6. The firmware package creation apparatus according to claim 1, wherein
the processor creates a directory as a storage part for storage of the acquired firmware data by type in the firmware data by a device storage unit of an auxiliary memory device according to the acquired firmware data by type.

7. The firmware package creation apparatus according to claim 1, wherein
the plurality of types of devices comprises multifunctional peripheral devices of different models from a manufacturer and multifunctional peripheral devices from different manufacturers.

8. A method of creating a firmware package in a firmware package creation apparatus including a processor and a storage device and creating a firmware package containing a plurality of pieces of firmware data for a plurality of types of devices, the method by the processor comprising:
classifying a plurality of files contained in firmware data by type as common files used in common in all types and files by device used only in a type as a target of the firmware data by type with respect to each of a plurality of pieces of the firmware data by type;
creating a first compressed file by collectively compressing only the common files from the plurality of pieces of firmware data by type based on the classification;
creating a second compressed file by collectively compressing only the files by device with respect to each of the plurality of pieces of firmware data by type for all of the plurality of pieces of firmware data by type, and thereby, creating a plurality of the second compressed files based on the classification; and
creating the firmware package by collectively compressing the first compressed file and the plurality of second compressed files.

9. The method according to claim 8, further comprising:
performing the classifying by hash comparison between the files having same file names contained in the plurality of pieces of firmware data by type.

10. The method according to claim 9, further comprising:
of the plurality of files having the same file names contained in the plurality of pieces of firmware data by type, even if one type has a different hash, classifying the files as the files by device in all types.

11. The method according to claim 9, further comprising:
creating a file list of files contained in the plurality of pieces of firmware data by type except the same file names in the storage device, and performing the hash comparison of the files described in the file list one by one.

12. The method according to claim 8, wherein the firmware package creation apparatus further comprises an interface with an external storage medium detachable from the firmware package creation apparatus,
the method further comprising:
storing the created firmware package in the external storage medium via the interface.

13. The method according to claim 8, further comprising:
creating a directory as a storage part for storage of the acquired firmware data by type in the firmware data by a device storage unit of an auxiliary memory device according to the acquired firmware data by type.

14. A firmware update system, comprising:
the firmware package creation apparatus according to claim 1; and
the plurality of types of devices each including a processor and a storage device and updating firmware data using the firmware package created by the firmware package creation apparatus, wherein
the processor of the device decompresses the firmware package and stores the first compressed file and the plurality of second compressed files in the storage device of the device,
the processor of the device restores the firmware data by type for the device by decompressing the first compressed file and the second compressed file corresponding to the device from the plurality of second compressed files, and
the processor of the device applies the firmware data by type.

15. The firmware update system according to claim 14, wherein
the processor performs the classification by hash comparison between the files having same file names contained in the plurality of pieces of firmware data by type.

16. The firmware update system according to claim 15, wherein
of the plurality of files having the same file names contained in the plurality of pieces of firmware data by type, even if one type has a different hash, the processor classifies the files as the files by device in all types.

17. The firmware update system according to claim 15, wherein
the processor creates a file list of files contained in the plurality of pieces of firmware data by type except the same file names in the storage device, and performs the hash comparison of the files described in the file list one by one.

18. The firmware update system according to claim 14, further comprising an interface with an external storage medium detachable from the firmware package creation apparatus, wherein
the processor stores the created firmware package in the external storage medium via the interface.

19. The firmware update system according to claim 14, wherein
the processor creates a directory as a storage part for storage of the acquired firmware data by type in the firmware data by a device storage unit of an auxiliary memory device according to the acquired firmware data by type.

20. The firmware update system according to claim 14, wherein
the plurality of types of devices comprises multifunctional peripheral devices of different models from a manufacturer and multifunctional peripheral devices from different manufacturers.
